(19) United States
(12) Patent Application Publication
(10) Pub. No.: US 2025/0128458 A1
(43) Pub. Date: Apr. 24, 2025

(54) INFORMATION PROCESSING SYSTEM AND NON-TRANSITORY COMPUTER READABLE MEDIUM STORING PROGRAM

(71) Applicant: SUMITOMO HEAVY INDUSTRIES, LTD., Tokyo (JP)

(72) Inventors: Takuya MIZUNASHI, Chiba-shi (JP); Katsunobu HANO, Chiba-shi (JP); Tomosuke KADOONO, Chiba-shi (JP); Shoki MIYAZAKI, Chiba-shi (JP)

(21) Appl. No.: 18/793,771

(22) Filed: Aug. 3, 2024

(30) Foreign Application Priority Data
Oct. 20, 2023 (JP) 2023-181230

(51) Int. Cl. B29C 45/76; B29C 45/17

(52) U.S. Cl. CPC B29C 45/76; B29C 45/1774; B29C 2045/7606; B29C 2945/76949

(57) ABSTRACT

An information processing system includes an acquisition unit that acquires an inference result of information relating to injection molding inferred based on information relating to a shot in the injection molding and information obtained in the shot; and a display control unit that causes a display unit to display a display screen which includes a waveform diagram indicating a temporal change in an actual value obtained in the shot, by using a waveform, and on which reference information based on the inference result is added to the waveform diagram.

### CROSS-REFERENCE TO RELATED APPLICATIONS

This application claims priority to Japanese Patent Application No. 2023-181230, filed on Oct. 20, 2023, which is incorporated by reference herein in its entirety.

### BACKGROUND

### Technical Field

A certain embodiment of the present invention relates to an information processing system and a non-transitory computer readable medium storing a program.

### Description of Related Art

Various sensors are provided in an injection molding machine, and various pieces of information obtained in association with an operation of the injection molding machine during manufacturing (shot) of molding products are acquired. In the related art, a display unit displays a waveform diagram indicating information based on an operation obtained in accordance with the operation of the injection molding machine.

The related art discloses a control device of an injection molding machine as follows. The control device includes an output unit that outputs waveform information in which each change in an item indicating an actual value measured in a process of the injection molding machine is represented by a waveform, to a display unit, and a reception unit that receives an operation for designating a range for the waveform information. The output unit outputs information indicating a feature of each item included in the designated range to any one or more of the display unit and a storage unit.

### SUMMARY

According to an embodiment of the present invention, there is provided an information processing system including: an acquisition unit that acquires inference data of information relating to injection molding inferred based on information relating to a shot in the injection molding and information obtained in the shot; and a display control unit that causes a display unit to display a display screen which includes a waveform diagram indicating a temporal change in an actual value obtained in the shot, by using a waveform, and on which reference information based on the inference data is added to the waveform diagram.

### BRIEF DESCRIPTION OF THE DRAWINGS

FIG. 1 is a view illustrating a configuration of an injection molding machine to which the present embodiment is applied.

FIG. 2 is a view illustrating a configuration of a control device.

FIG. 3 is a view illustrating a configuration of a data processing device.

FIG. 4 is a view illustrating a configuration of an information processing device.

FIG. 5 is a view illustrating a hardware configuration example of a computer that realizes the information processing device.

FIG. 6 is a view illustrating an example of a display screen displayed on a display unit by the information processing device.

FIG. 7 is a view illustrating an example of the display screen to which reference information is added.

FIG. 8 is a view illustrating another example of the display screen to which the reference information is added.

FIG. 9 is a view illustrating another example of the display screen to which the reference information is added.

FIG. 10 is a view illustrating another example of the display screen to which the reference information is added.

FIG. 11 is a view illustrating another example of the display screen to which the reference information is added.

FIG. 12 is a view illustrating another example of a display screen to which reference information is added.

FIG. 13 is a view illustrating another example of the display screen to which the reference information is added.

FIG. 14 is a view illustrating another example of the display screen to which the reference information is added.

FIG. 15 is a view illustrating an example of an inference execution condition for each model.

FIG. 16 is a flowchart illustrating an operation of a processing unit when inference is executed based on conditions illustrated in FIG. 15.

### DETAILED DESCRIPTION

When a molding product is manufactured by an injection molding machine, settings for molding conditions or the like are adjusted in accordance with quality of the molding product. Here, when information acquired from the injection molding machine is displayed as a waveform diagram, information on a correction amount, a setting value, or the like obtained by inference with regard to the molding conditions or the like (hereinafter, referred to as “inference information”) is presented. In this manner, user's work for setting the molding conditions or the like can be supported.

It is desirable to display inference information relating to the molding conditions together with the waveform diagram indicating the information acquired from the injection molding machine, and to support user's settings for the injection molding machine.

Hereinafter, an embodiment of the present invention will be described in detail with reference to the accompanying drawings.

### Device Configuration

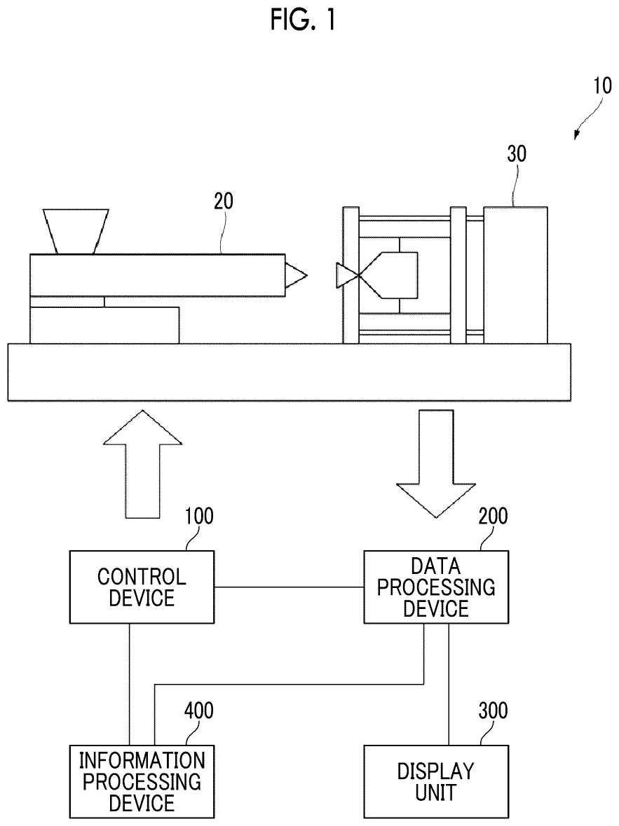

FIG. 1 is a view illustrating a configuration of an injection molding machine to which the present embodiment is applied. An injection molding machine 10 includes an injection unit 20, a mold clamping unit 30, a control device 100, a data processing device 200, and a display unit 300. In addition, the information processing device 400 is connected to the control device 100 and the data processing device 200.

The injection unit 20 includes a cylinder that heats a molding material, a screw rotatable inside the cylinder and provided to be able to advance and retreat in an axial direction, a rotary motor that drives the screw in a rotation direction, a motor that drives the screw in the axial direction, and the like. For example, the molding material is a resin or the like. The injection unit 20 injects the molding material heated and liquefied inside the cylinder by advancing in a direction (forward) toward the mold clamping unit 30 from the injection unit 20 while rotating the screw, and fills a mold of the mold clamping unit 30 disposed in front of the injection unit 20 with the molding material. For example, the injection unit 20 performs a plasticizing process, a filling process, a holding pressure process, or the like during a manufacturing process of a molding product. The filling process and the holding pressure process may be collectively referred to as an injection process.

The mold clamping unit 30 includes a mold, a fastening mechanism that fastens the mold, and a motor that drives the fastening mechanism. The mold clamping unit 30 closes the mold, and receives the molding material injected from the injection unit 20 into the mold. At this time, the mold clamping unit 30 causes the fastening mechanism to fasten the mold so that the mold is not opened when the mold is filled with the molding material (mold clamping). The molding product is produced by solidifying the molding material which fills the mold. Thereafter, the mold clamping unit 30 opens the mold, and the produced molding product can be taken out. For example, the mold clamping unit 30 performs a mold closing process, a pressurization process, a mold clamping process, a depressurization process, a mold opening process, or the like during the manufacturing process of the molding product.

The control device 100 is a device that controls operations of the injection unit 20 and the mold clamping unit 30. The data processing device 200 is a device that processes data obtained in association with the operations of the injection unit 20 and the mold clamping unit 30. The display unit 300 displays information relating to control of the injection unit 20 and the mold clamping unit 30 via the control device 100, data acquired by the data processing device 200, a processing result of the data processing device 200, and the like. In addition, the display unit 300 displays an input screen for performing an operation for inputting a command or data to the control device 100 or the data processing device 200.

The information processing device 400 acquires information relating to the operation of the injection molding machine 10 from the control device 100 and the data processing device 200, generates a screen for presenting the acquired information to a user, and displays the screen on the display unit. The information acquired by the information processing device 400 includes setting information in the injection unit 20 and the mold clamping unit 30, actual values obtained by performing various processes, and the like. In addition, the information processing device 400 causes the display unit to display information obtained by inference using an inference model such as machine learning with regard to the operation of the injection molding machine 10, together with information acquired from the control device 100 and the data processing device 200.

### Configuration of Control Device 100

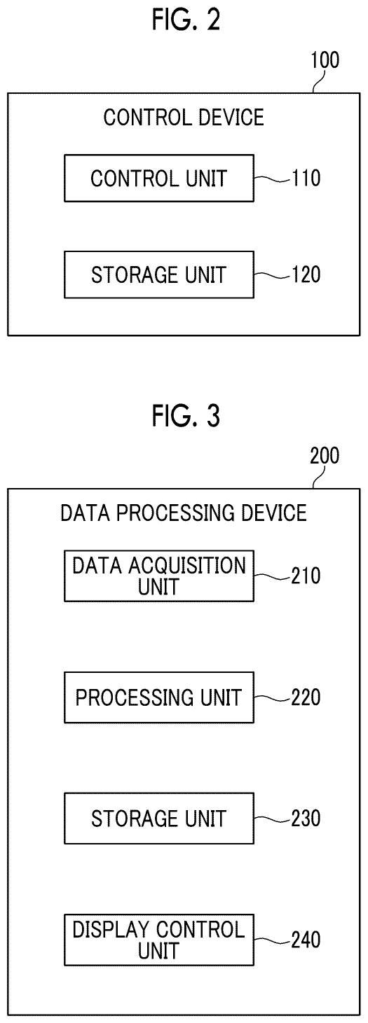

FIG. 2 is a view illustrating a configuration of the control device 100. The control device 100 controls operations of the injection unit 20 and the mold clamping unit 30. For example, the control device 100 is realized by a computer. The control device 100 includes a control unit 110 and a storage unit 120. The control device 100 controls the injection unit 20 and the mold clamping unit 30, and repeatedly performs a process relating to manufacturing of the molding product, thereby repeatedly manufacturing the molding products. The process relating to the manufacturing of the molding product includes a plasticizing process, a mold closing process, a pressurization process, a mold clamping process, a filling process, a holding pressure process, a cooling process, a depressurization process, a mold opening process, an ejection process, and the like. Hereinafter, these processes relating to the manufacture may be collectively referred to as a “manufacturing process”. In addition, a series of operations for obtaining the molding products, for example, an operation from the start of the plasticizing process to the start of the subsequent plasticizing process in the above-described manufacturing process will be referred to as a “shot”, a “molding cycle”, or the like. The above-described processes for manufacturing the molding products are merely examples. For example, the processes may include other processes which are not included in the above-described processes as a process executed in one shot.

The control unit 110 controls the injection unit 20 and the mold clamping unit 30, based on control information. The control information includes a condition set by the user and a fixedly determined condition. For example, the condition set by the user is generated, based on information input by the user using an input unit (not illustrated). For example, the control information includes molding conditions such as a cylinder temperature (resin temperature), a mold temperature, an injection holding pressure time, a plasticizing value, a V-P switching position, a holding pressure, an injection speed (filling speed), a screw rotation speed, a screw back pressure, a mold clamping force, and the like. A plurality of combinations of the molding conditions are determined depending on the molding product or the mold. Hereinafter, combination data of the molding conditions will be referred to as a molding condition data set. The molding condition data set is prepared in accordance with a type of the molding product or the mold, and is stored in the storage unit 120.

The control unit 110 controls the injection unit 20 and the mold clamping unit 30 by using the above-described molding condition data set, and performs a process relating to the manufacturing (shot) of the molding product which includes each of the above-described processes. The control unit 110 reads the molding condition data set corresponding to the molding product to be manufactured from the storage unit 120, when the manufacturing of the molding product starts. The control unit 110 controls the operations of the injection unit 20 and the mold clamping unit 30, based on control information including the read molding condition data set. Specifically, the control unit 110 controls the injection unit 20 and the mold clamping unit 30 such that data obtained from the injection unit 20 and the mold clamping unit 30 during the manufacturing process coincides with a setting value of the molding condition data set. In addition, the control unit 110 may cause the display unit 300 to display the molding condition data set read from the storage unit 120. The user may refer to the data of the molding conditions displayed on the display unit 300, and may perform an operation such as value correction when necessary.

The storage unit 120 holds the control information used by the control unit 110 to control the injection unit 20 and the mold clamping unit 30. The molding condition data set included in the control information is prepared in association with the molding product serving as a manufacturing target or the mold. The storage unit 120 holds the molding condition data set for each molding product serving as the manufacturing target or each mold. In addition, although not illustrated, the storage unit 120 holds a program for the control unit 110 to control the injection unit 20 and the mold clamping unit 30. Although details will be described later, functions of the control unit 110 are realized in such a manner that a processor in the control device 100 reads and executes the program held in the storage unit 120.

### Configuration of Data Processing Device 200

FIG. 3 is a view illustrating a configuration of the data processing device 200. The data processing device 200 acquires and processes data obtained in association with the operations performed by the injection unit 20 and the mold clamping unit 30 in the process relating to the manufacturing of the molding product. For example, the data processing device 200 is realized by a computer. The data processing device 200 includes a data acquisition unit 210, a processing unit 220, a storage unit 230, and a display control unit 240.

The data acquisition unit 210 acquires processing target data from the injection unit 20 and the mold clamping unit 30. Various sensors, detectors, or the like are attached to the injection unit 20 and the mold clamping unit 30. In addition, in some cases, various measuring instruments may be connected to the injection unit 20 or the mold clamping unit 30. Data acquired by using the sensors, the detectors, the measuring instruments, or the like (hereinafter, referred to as “acquired data”) is information indicating a molding result obtained by the injection unit 20 and the mold clamping unit 30, and is used for quality control of the molding product. The data acquisition unit 210 receives the acquired data transmitted from the sensor, the detector, the measuring instrument, or the like, and stores the acquired data in the storage unit 230.

The processing unit 220 processes the acquired data stored in the storage unit 230. Specifically, the processing unit 220 performs processing such as extracting a representative value of the acquired data in each process and generating time-series data in which the acquired data in each process is processed in a time-series manner. In extracting the representative value, the processing unit 220 performs statistical processing on the acquired data, such as calculating an average value, specifying a possible range of values, and specifying a maximum value or a minimum value.

The storage unit 230 holds the acquired data acquired by the data acquisition unit 210. As a data format of the acquired data held in the storage unit 230, for example, binary, text, Comma Separated Values (CSV), INI, YAML Ain't Markup Language (YAML), JavaScript Object Notation (JSON), or the like may be used. Since these general-purpose data formats are used as a data file, the data file held in the storage unit 230 can be used for data exchange with other information processing devices or the data file acquired from an external device can be edited. In addition, although not illustrated, the storage unit 230 holds a program for the processing unit 220 to execute data processing, a program for the display control unit 240 to display a screen on the display unit 300, and a program for receiving a user's operation performed on an operation screen. Although details will be described later, functions of the processing unit 220 and the display control unit 240 are realized in such a manner that the processor in the data processing device 200 reads and executes the program held in the storage unit 230.

The display control unit 240 generates a screen for notifying the user of a processing result obtained by the processing unit 220, and displays the screen on the display unit 300. In addition, the display control unit 240 generates an operation screen for the user to perform various operations, and displays the operation screen on the display unit 300.

### Configuration of Information Processing Device 400

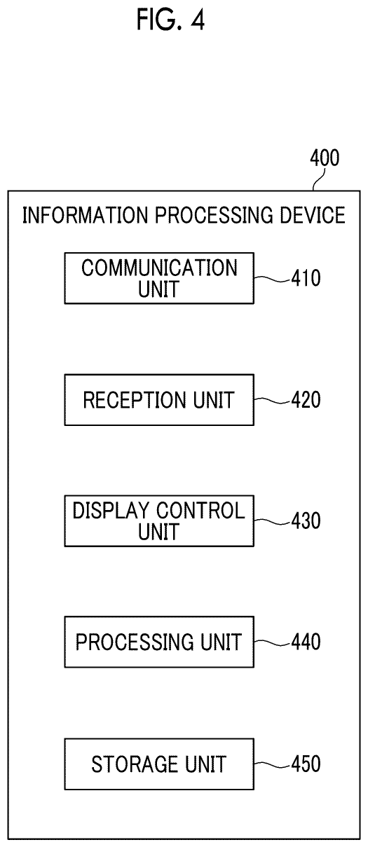

FIG. 4 is a view illustrating a configuration of the information processing device 400. The information processing device 400 causes the display unit to display a waveform diagram indicating information relating to the operation of the injection molding machine 10 which is obtained from the control device 100 and the data processing device 200, and information obtained by inference using the inference model. For example, the information processing device 400 is realized by a computer. The information processing device 400 includes a communication unit 410, a reception unit 420, a display control unit 430, a processing unit 440, and a storage unit 450. In addition, although not illustrated, an input unit and a display unit are connected to the information processing device 400.

The communication unit 410 receives information relating to the operation of the injection molding machine 10 from the control device 100 and the data processing device 200. Specifically, the communication unit 410 receives the molding conditions used for the control unit 110 to control the injection unit 20 and the mold clamping unit 30 in the control device 100, and the acquired data acquired from the sensors or the like of the injection unit 20 and the mold clamping unit 30 by the data acquisition unit 210 in the data processing device 200. The information received by the communication unit 410 is information used for processing of the processing unit 440 (to be described later), and is not necessarily all information such as the above-described molding conditions and the acquired data. The communication unit is an example of the acquisition unit.

The reception unit 420 receives a user's operation of the input unit. The user uses the input unit to perform various operations such as selecting a screen displayed on the display unit by the display control unit 430, and instructing the processing unit 440 to execute processing. The reception unit 420 receives the operations, and transmits an instruction corresponding to the received operation to the display control unit 430 or the processing unit 440.

The display control unit 430 causes the display unit to display the waveform diagram indicating the information relating to the operation of the injection molding machine 10 which is received by the communication unit 410. In addition, the display control unit 430 causes the display unit to display inference data inferred by the processing unit 440. Details of the screen displayed on the display unit by the display control unit 430 will be described later.

The processing unit 440 processes the information received by the communication unit 410. Specifically, the processing unit 440 generates the waveform diagram, based on time-series data of an actual value for each shot obtained from the received information. In addition, the processing unit 440 includes an inference engine, and infers information relating to the injection molding of the injection unit 20 and the mold clamping unit 30 which is required for manufacturing the molding product having good quality, based on the received information. For example, the information inferred by the processing unit 440 is information such as a recommendation value of a specific item under the molding conditions, a time point (timing) at which a specific event occurs during the operation of the shot via the injection unit 20 and the mold clamping unit 30, and the like. The processing unit 440 is an example of an inference execution unit. In addition, the processing unit 440 is an example of an acquisition unit that acquires an inference result obtained by executing the inference.

The storage unit 450 holds a data file of the information received by the communication unit 410 and the information obtained by the inference of the processing unit 440. For example, the data file is held in association with the manufacturing target molding product or the mold in the shot from which the information is obtained. As a data format of the data file held in the storage unit 450, for example, Comma Separated Values (CSV), Extensible Markup Language (XML), JavaScript Object Notation (JSON), or the like can be used. In addition, the storage unit 450 holds an inference model used for the inference of the processing unit 440.

### Hardware Configuration of Information Processing Device 400

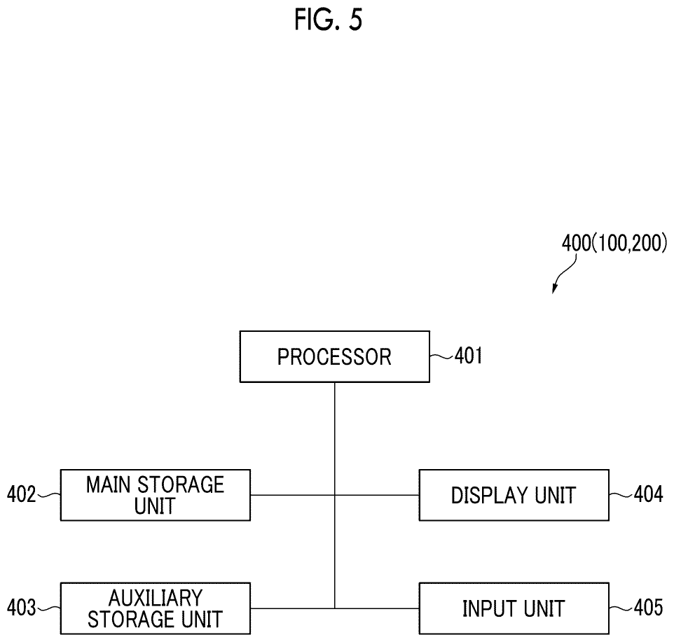

FIG. 5 is a view illustrating a hardware configuration example of a computer which realizes the information processing device 400. The computer illustrated in FIG. 5 includes a processor 401 serving as calculation means, a main storage unit (main memory) 402 serving as storage means, and an auxiliary storage unit 403. For example, as the processor 401, a Central Processing Unit (CPU), a Graphics Processing Unit (GPU), an Application-Specific Integrated Circuit (ASIC), a Field-Programmable Gate Array (FPGA), or other various calculation circuits can be used. The processor 401 reads a program stored in the auxiliary storage unit 403 into the main storage unit 402, and executes the program. For example, a Random-Access Memory (RAM) is used as the main storage unit 402. For example, a magnetic disk device, a Solid-State Drive (SSD), or the like is used as the auxiliary storage unit 403.

In addition, the computer includes a display unit 404 for displaying an image and an input unit 405 as input means for an input operation performed by a user of the computer. As the input unit 405, for example, a keyboard, a mouse, a touch panel, or the like is used. When the touch panel configured integrally with the display unit 404 is used as the input unit 405, the user performs the input operation by touching an operation screen displayed on the display unit 404 with a finger or a pen-type device. In addition, the configuration of the computer illustrated in FIG. 5 is merely an example, and the computer used in the present embodiment is not limited to the configuration example in FIG. 5. For example, a non-volatile memory such as a flash memory or a Read-Only Memory (ROM) may be provided as the storage unit.

When the information processing device 400 is realized by the computer illustrated in FIG. 5, for example, the communication unit 410 is realized by the processor 401 that reads and executes the program and a communication interface (not illustrated). For example, the reception unit 420 is realized by the processor 401 that reads and executes the program, and the input unit 405. For example, functions of the display control unit 430 and the processing unit 440 are realized by the processor 401 that reads and executes the program. For example, the storage unit 450 is realized by the auxiliary storage unit 403.

In addition, the control device 100 and the data processing device 200 of the injection molding machine 10 may be realized by the computer configured as illustrated in FIG. 5. When the control device 100 is realized by the computer illustrated in FIG. 5, for example, functions of the control unit 110 are realized by the processor 401 that reads and executes the program. For example, the storage unit 120 is realized by the auxiliary storage unit 403. When the data processing device 200 is realized by the computer illustrated in FIG. 5, for example, functions of the data acquisition unit 210 and the processing unit 220 are realized by the processor 401 that reads and executes the program. For example, the storage unit 230 is realized by the auxiliary storage unit 403. For example, the display control unit 240 is realized by the processor 401 that reads and executes the program, and the display unit 404.

### Configuration Example of Display Screen

The information processing device 400 generates a display screen including the waveform diagram indicating the information relating to the operation of the injection molding machine 10, and causes the display unit (for example, the display unit 404 illustrated in FIG. 5) to display the display screen by adding the information obtained by the inference to the waveform diagram. Hereinafter, a configuration example of the display screen will be described. In the following description, information obtained by inference added to the waveform diagram will be referred to as “reference information”.

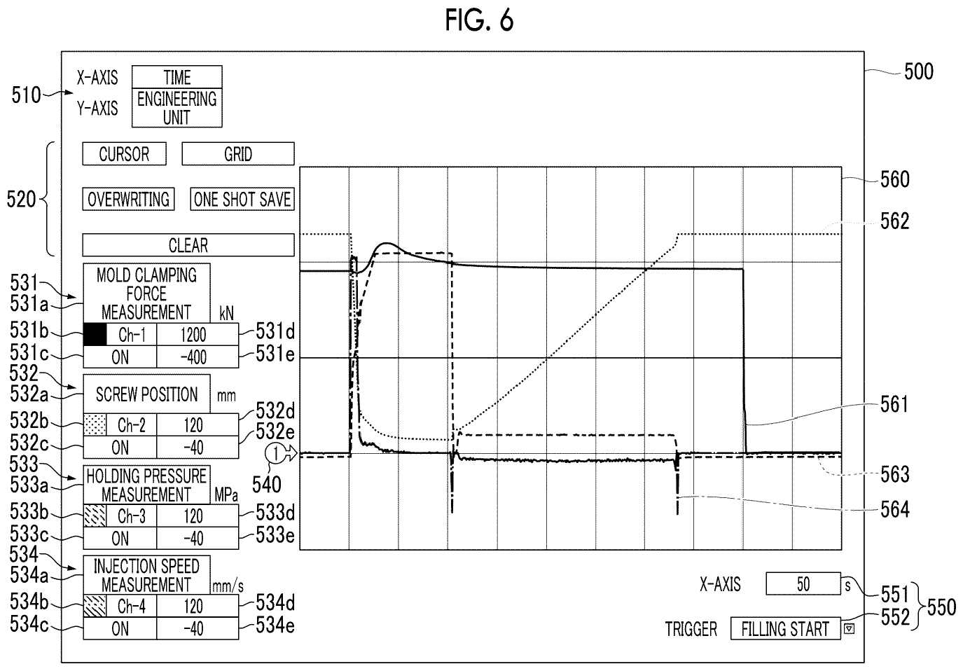

FIG. 6 is a view illustrating an example of a display screen 500 displayed on the display unit by the information processing device 400. The display screen 500 illustrated in FIG. 6 does not display the reference information based on the inference. First, a basic configuration of a screen for displaying the waveform diagram of information relating to the operation of the injection molding machine 10 will be described with reference to FIG. 6. The display screen 500 illustrated in FIG. 6 includes an X-Y-axis unit display section 510, a command operation section 520, item display sections 531 to 534, a setting information display section 550, and a waveform display section 560.

The X-Y-axis unit display section 510 is a display section that displays unit settings for an X-axis and a Y-axis of the waveform display section 560. In the example illustrated in FIG. 6, a “time” is set on the X-axis, and an “engineering unit” is set on the Y-axis. In FIG. 6, an axis in a horizontal direction of the waveform display section 560 is defined as an X-axis, and an axis in a vertical direction is defined as a Y-axis. Other units may be set on the X-axis and the Y-axis in accordance with a type of target items in which the waveform diagram is displayed on the waveform display section 560. For example, the X-axis may be referred to as a “screw position” or the like, and the Y-axis may be referred to as a “ratio” or the like.

The command operation section 520 is a display section in which a button object for performing a command operation on the display of the display screen 500 is disposed. In the example illustrated in FIG. 6, five button objects of “cursor”, “grid”, “overwriting”, “one shot save”, and “clear” are displayed. The “cursor” is a button for displaying a cursor on the screen of the waveform display section 560. The “grid” is a button for displaying a grid on the screen of the waveform display section 560. The “overwriting” is a button for displaying the waveform display section 560 in a display format in which the waveform diagrams of the waveform display section 560 are continuously overwritten for subsequent shots without erasing the waveform diagram of the waveform display section 560 for each shot. The “one shot save” is a button for performing an operation of saving the subsequent one shot waveform data in a file. The “clear” is a button for erasing the waveform diagram and the related information which are displayed on the waveform display section 560.

The item display sections 531 to 534 are display sections for selecting a target item in which the waveform diagram is displayed on the waveform display section 560. In the item display sections 531 to 534, a channel is assigned to each target item, and settings relating to the display of the waveform diagram are illustrated. In the example illustrated in FIG. 6, display fields assigned to four channels are illustrated as the item display sections 531 to 534. The number of channels of the item display sections 531 to 534 is not limited to four in the illustration. The number of channels may be less than four, or may be more than four depending on a size or resolution of the display screen.

A configuration of the display field of the item display sections 531 to 534 will be described. Since the item display sections 531 to 534 for each channel have the same configuration, a configuration of the display field of the item display section 531 for a first channel will be described, and description of the item display sections 532 to 534 for the other channels will be omitted. The item display section 531 includes an item name display field 531a, a channel display field 531b, an on/off switch 531c, a maximum value display field 531d, and a minimum value display field 531e.

The name of the target item displayed in the waveform diagram is displayed in the item name display field 531a. The user can designate the target item to be displayed in the waveform diagram by inputting the item name to the item name display field 531a. A channel number of the item display section 531 is displayed in the channel display field 531b. The on/off switch 531c indicates whether the waveform diagram of the corresponding channel is in a display state (on) or a non-display state (off). The user can switch between the display and the non-display of the waveform diagram by selecting the display of the channel display field 531b.

The maximum value display field 531d indicates a maximum value set for the display of the waveform diagram of the corresponding channel in the waveform display section 560. The minimum value display field 531e indicates a minimum value set for the display of the waveform diagram of the corresponding channel in the waveform display section 560. The user can set the maximum value and the minimum value of the corresponding target item in the waveform display section 560 by inputting numerical values to the maximum value display field 531d and the minimum value display field 531e. A display scale in the Y-axis direction of the waveform diagram displayed on the waveform display section 560 is specified by the numerical values input to the maximum value display field 531d and the minimum value display field 531e. In the item display section 531 illustrated in FIG. 6, units of the maximum value and the minimum value which are displayed in the maximum value display field 531d and the minimum value display field 531e are displayed at a right side position of the item name display field 531a in an upper portion of the maximum value display field 531d.

In the example illustrated in FIG. 6, the item display section 531 corresponds to the first channel (Ch-1), and displays information on a measurement value of a mold clamping force. Specifically, “mold clamping force measurement” is displayed in the item name display field 531a, and “Ch-1” is displayed in the channel display field 531b. In addition, since the on/off switch 531c is “On”, the waveform diagram for the measurement value of the mold clamping force is displayed on the waveform display section 560. Since a value of the maximum value display field 531d is “1,200”, a value of the minimum value display field 531e is “−400”, and the unit is “kN” (kilonewton), the display scale of the waveform diagram of the measurement value of the mold clamping force is 1,200 kN to −400 kN.

In addition, the item display section 532 corresponds to a second channel (Ch-2), and displays information on a screw position. Specifically, the “screw position” is displayed in the item name display field 532a, and the “Ch-2” is displayed in the channel display field 532b. In addition, since the on/off switch 532c is “On”, the waveform diagram for the screw position is displayed on the waveform display section 560. Since the value of the maximum value display field 532d is “120”, the value of the minimum value display field 532e is “−40”, and the unit is “mm” (millimeter), the display scale of the waveform diagram of the screw position is 120 mm to −40 mm.

In addition, the item display section 533 corresponds to a third channel (Ch-3), and displays information on a measurement value of a holding pressure. Specifically, the “holding pressure measurement” is displayed in the item name display field 533a, and the “Ch-3” is displayed in the channel display field 533b. In addition, since the on/off switch 533c is “On”, the waveform diagram for the measurement value of the holding pressure is displayed on the waveform display section 560. Since the value of the maximum value display field 533d is “120”, the value of the minimum value display field 533e is “−40”, and the unit is “MPa” (mega pascal), the display scale of the waveform diagram of the measurement value of the holding pressure is 120 MPa to −40 MPa.

In addition, the item display section 534 corresponds to a fourth channel (Ch-4), and displays information on a measurement value of an injection speed. Specifically, the “injection speed measurement” is displayed in the item name display field 534a, and the “Ch-4” is displayed in the channel display field 534b. In addition, since the on/off switch 534c is “ON”, the waveform diagram for the measurement value of the injection speed is displayed on the waveform display section 560. Since the value of the maximum value display field 534d is “120”, the value of the minimum value display field 534e is “−40”, and the unit is “mm/s” (millimeter per second), the display scale of the waveform diagram of the measurement value of the injection speed is 120 mm/s to −40 mm/s.

The setting information display section 550 is a display section for setting the display of the waveform display section 560. In the example illustrated in FIG. 6, the setting information display section 550 is provided with an X-axis information display field 551 and a trigger display field 552 (displayed as a “trigger” in the drawing).

The display scale in the X-axis direction in the waveform display section 560 is displayed in the X-axis information display field 551. The user can specify the display scale in the X-axis direction of the waveform diagram displayed on the waveform display section 560 by inputting a numerical value to the X-axis information display field 551. In the example illustrated in FIG. 6, the numerical value “50” is input, and the waveform diagram having a length of 50 seconds(s) is displayed on the waveform display section 560.

The trigger display field 552 displays the setting of a trigger position of the waveform diagram in the waveform display section 560. The user can set the trigger position of the waveform diagram by selecting the display of the trigger display field 552. The trigger position is a reference position for drawing the waveform diagram in the waveform display section 560. In the example illustrated in FIG. 6, “filling start” is selected as the trigger position, and the waveform diagram is drawn, based on a time point at which the mold of the mold clamping unit 30 starts to be filled with the molding material. The trigger position is a reference time point for specifying a time point serving as an inference target during the operation of the shot.

The waveform display section 560 is a display section that displays the waveform diagram of each target item specified by the item display sections 531 to 534. In the waveform display section 560, the horizontal direction is defined as the X-axis, and the vertical direction is defined as the Y-axis. For example, a left side is a small value, and a right side is a great value on the X-axis. Therefore, when the X-axis represents a time, a time elapses from a left end to a right end. In addition, for example, a lower side is the small value, and the upper side is the great value on the Y-axis. The waveform display section 560 displays the waveform diagram indicating the time-series data of the corresponding target item with regard to the target item specified by the item display sections 531 to 534 of each channel. The example illustrated in FIG. 6 displays each of a waveform diagram 561 of the measurement value of the mold clamping force which is the target item specified by the item display section 531 of the first channel, a waveform diagram 562 of the screw position which is the target item specified by the item display section 532 of the second channel, a waveform diagram 563 of the measurement value of the holding pressure which is the target item specified by the item display section 533 of the third channel, and a waveform diagram 564 of the measurement value of the injection speed which is the target item specified by the item display section 534 of the fourth channel.

The waveform diagrams 561 to 564 are displayed in accordance with the display scales in the Y-axis direction specified by the numerical values input to the maximum value display fields 531d to 534d and the minimum value display fields 531e to 534e in the item display sections 531 to 534 of the respective channels, the display scales in the X-axis direction specified by the numerical values input to the X-axis information display field 551 of the setting information display section 550, and the settings such as the trigger position specified by the trigger display field 552 of the setting information display section 550.

In the waveform display section 560, a reference position mark 540 is displayed on the Y-axis on the left end. The reference position mark 540 indicates a reference position (origin) in the Y-axis direction in each of the waveform diagrams 561 to 564. The reference position mark 540 is displayed for each of the waveform diagrams 561 to 564. However, in the example illustrated in FIG. 6, the reference position marks 540 for the respective waveform diagrams 561 to 564 are displayed to overlap each other at the same position, and only the reference position mark 540 (displaying the channel number “1”) of the first channel is in a visually recognized state.

The reference position mark 540 is movable on the Y-axis of the waveform display section 560 via a Graphical User Interface (GUI). The user may change the display position of the reference position mark 540 via an intuitive operation for moving the reference position mark 540 on the display screen 500. When the position of the reference position mark 540 is changed, the waveform diagrams 561 to 564 corresponding to the reference position mark 540 whose position is changed in the waveform display section 560 move in the Y-axis direction (vertical direction) in accordance with the movement of the reference position mark 540.

In the example illustrated in FIG. 6, the X-axis (horizontal direction) of the waveform display section 560 is provided with 11 scales (vertical lines) from the left end to the right end. Here, in the waveform display section 560, the trigger position is set at a first scale mark on the X-axis of the waveform display section 560. In other words, the waveform from the left end on the X-axis of the waveform display section 560 to the first scale mark is a waveform before the trigger position in the operation of the shot. The waveform diagram after the trigger position is displayed subsequently to the first scale mark (right side) on the X-axis of the waveform display section 560. Therefore, on the X-axis of the waveform display section 560, 10 scales are set from the first scale mark to the right end. Since the display scale is 50 seconds from the value in the X-axis information display field 551 of the setting information display section 550, the length of one scale in the waveform display section 560 in FIG. 6 is five seconds.

### Display Example of Reference Information

Next, the display of reference information on the display screen 500 will be described. The reference information is information relating to the injection molding inferred by the processing unit 440 of the information processing device 400, based on the information obtained in the shot. The reference information is information that is additionally displayed on the waveform display section 560. The reference information is displayed together with the waveform diagram based on the actual value in the waveform display section 560. In association with the display of the reference information, in some cases, the display screen 500 may additionally display the setting, the control information, or the like relating to the display of the reference information. Hereinafter, in addition to the reference information, the additionally displayed information will also be described.

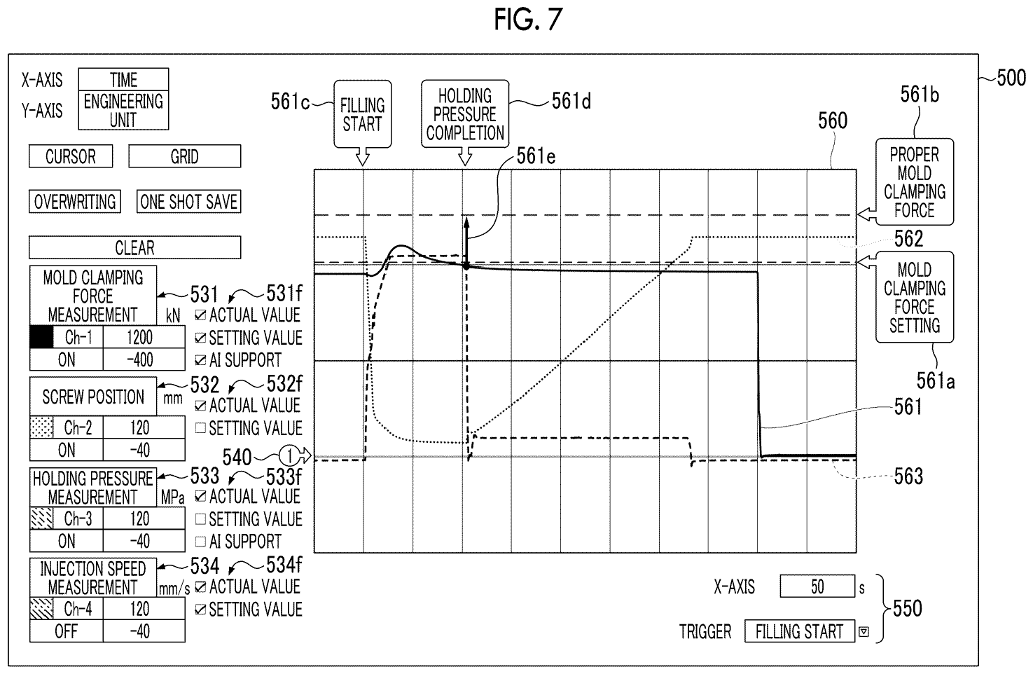

FIG. 7 is a view illustrating an example of the display screen 500 to which the reference information is added. In the display screen 500 illustrated in FIG. 7, the configuration excluding the display of the reference information and the display (hereinafter, referred to as an “additional display”) added in association with the reference information is the same as that of the display screen 500 described with reference to FIG. 6. Specifically, the X-Y-axis unit display section 510, the command operation section 520, the item display sections 531 to 534, the reference position mark 540, and the setting information display section 550 are the same configurations as those illustrated in FIG. 6. However, in FIG. 7, unlike FIG. 6, the on/off switch in the item display section 534 of the fourth channel is “Off”. Therefore, in the waveform display section 560 in FIG. 7, the waveform diagram 564 of the measurement value of the injection speed corresponding to the fourth channel is not displayed. In addition, in order to easily view the drawing, in FIG. 7, reference numerals are not assigned to the X-Y-axis unit display section 510, the command operation section 520, and each of the fields 531a to 531e, 532a to 532e, 533a to 533e, and 534a to 534e of the item display sections 531 to 534. However, hereinafter, description will be made by appropriately assigning the same reference numerals as those in FIG. 6.

In the display screen 500 illustrated in FIG. 7, display setting fields 531f to 534f for setting whether or not to display or additionally display the waveform diagram and the reference information are displayed on the item display sections 531 to 534 of each channel. Each of the display setting fields 531f to 534f may include each setting item of an “actual value”, a “setting value”, and an “AI support”, and a check box provided for each setting item. The check box is an input unit for setting whether or not to display the waveform diagram on the waveform display section 560.

The “actual value” is an actual value acquired, based on the operation of the injection molding machine 10 in the shot. When the check box of the “actual value” is checked, the waveform diagrams 561 to 564 indicating the time-series data of the corresponding setting items are displayed on the waveform display section 560.

The “setting value” is a setting value such as molding conditions set by the control device 100. When the check box of the “setting value” is checked, the waveform display section 560 performs an additional display indicating the setting value of the corresponding setting item. In addition, the “setting value” is not displayed in the display setting fields 531f to 534f with regard to the target items which are not set in the molding conditions.

The “AI support” is reference information inferred by the processing unit 440. When the check box of the “AI support” is checked, the reference information inferred with regard to the corresponding setting item is displayed on the waveform display section 560. In addition, the “AI support” is not displayed in the display setting fields 531f to 534f with regard to the target item for which a model for inference is not prepared. For example, the “AI support” is not displayed in the display setting field 532f of the second channel and the display setting field 534f of the fourth channel.

The display setting field 531f of the first channel displays the “actual value”, the “setting value”, and the “AI support”, and all of the check boxes of the setting items are checked. In this manner, the waveform display section 560 displays the waveform diagram 561 of the measurement value of the mold clamping force assigned to the first channel, a setting value of the mold clamping force in the shot, and a recommendation value of the mold clamping force obtained by the inference of the processing unit 440.

The “actual value” and the “setting value” are displayed in the display setting field 532f of the second channel, and only the check box of the “actual value” is checked. In this manner, the waveform display section 560 displays the waveform diagram 562 of the screw position assigned to the second channel. Since the check box of the “setting value” is not checked, the setting value of the screw position in this shot is not displayed on the waveform display section 560. In addition, the setting item “AI support” is not displayed in the display setting field 532f of the second channel, and the reference information relating to the screw position is not also displayed on the waveform display section 560.

The display setting field 533f of the third channel displays the “actual value”, the “setting value”, and the “AI support”, and only the check box of the “actual value” is checked. In this manner, the waveform display section 560 displays the waveform diagram 563 of the measurement value of the holding pressure assigned to the third channel. Since the check boxes of the “setting value” and the “AI support” are not checked, the setting value of the holding pressure in this shot and the reference information relating to the holding pressure are not displayed on the waveform display section 560.

The “actual value” and the “setting value” are displayed in the display setting field 532f of the fourth channel, and both of the check boxes are checked. However, since the on/off switch of the item display section 534 of the fourth channel is “Off”, the display relating to the measurement value of the injection speed is not performed in the waveform display section 560 regardless of the setting in the display setting field 534f.

The waveform display section 560 illustrated in FIG. 7 displays the waveform diagrams 561 to 563 of the first to third channels in accordance with the checks in the display setting fields 531f to 534f. In addition, the setting value and the recommendation value as the reference information obtained by inference of the processing unit 440 are illustrated with regard to the mold clamping force assigned to the first channel. Specifically, in the waveform display section 560, a label 561a (label on which the “mold clamping force setting” is written) disposed at a specific position on the Y-axis (right side in the drawing) indicates the setting value of the mold clamping force in this shot. In the waveform display section 560, a label 561b (label on which a “proper mold clamping force” is written) disposed at a specific position on the Y-axis (position above the label 561a) indicates the recommendation value of the mold clamping force in the shot. In addition, in the waveform display section 560, a broken line parallel to the X-axis (horizontal direction) is displayed at each position corresponding to the label 561a and the label 561b. The labels 561a and 561b and the broken line are examples of the additional display.

In the example illustrated in FIG. 7, in the waveform display section 560, when a figure indicating the recommendation value which is an inferred value is displayed together with the waveform diagram (in the illustrated example, the waveform diagram 561), a broken line indicating the recommendation value is displayed, and the label (in the illustrated example, the label 561a) indicating the content of the broken line is added. Here, the broken line and the label are examples of the figure indicating the inferred value. When the inference value is displayed, it is preferable that the inferred value is displayed to overlap the display of the actual value or the setting value in the waveform display section 560. In addition, it is preferable to change an appearance of the display of the actual value or the setting value and the display of the inferred value. For example, a line type (solid line, broken line, or the like) may be changed, a color or a thickness of the line may be changed, or an interval of the broken line may be changed. In addition, unlike the actual value, it is preferable to add the label to the inferred value. In addition, the inferred value may be represented by a line segment parallel to the axial direction (X-axis, Y-axis). In this case, the label may be omitted, and only the line segment may be displayed. A different display may be performed for each axial direction, for example, by displaying only the line segment parallel to the X-axis direction depending on the amount or inclination of the lines displayed on the waveform display section 560 and omitting the line segment parallel to the Y-axis direction.

The recommendation value is a value at a specific time point during the operation of the shot via the injection molding machine 10 (in the first channel in FIG. 7, a value of the mold clamping force). The specific time point is specified depending on selection of the user or a specification of the inference model. Here, a time when the holding pressure as an event that affects the mold clamping force is completed is set as a specific time point, and the recommendation value of the mold clamping force at this time point is inferred. The waveform display section 560 illustrated in FIG. 7 illustrates a holding pressure completion time and a filling start time specified by the trigger display field 552 of the setting information display section 550 as the trigger position serving as a reference for specifying the holding pressure completion time. Specifically, in the waveform display section 560, a label 561c (label on which the “filling start” is written) disposed at a specific position on the X-axis (upper side in the drawing) indicates the filling start time in this shot. In the waveform display section 560, a label 561d (label on which the “holding pressure completion” is written) disposed at a specific position on the X-axis (right position from the label 561c) indicates the holding pressure completion time in this shot. The labels 561c and 561d are examples of the additional display.

In addition, the waveform display section 560 illustrated in FIG. 7 displays a difference between the actual value at the specific time point and the recommendation value. Specifically, an arrow 561e directed from the waveform diagram 561 to the broken line of the recommendation value of the waveform diagram 561 is displayed between the value of the waveform diagram 561 at the holding pressure completion time (position indicated by the label 561d) and the recommendation value (position of the broken line corresponding to the label 561b). The user can recognize how much the mold clamping force needs to be changed at the holding pressure completion time by referring to the arrow 561e.

In the above-described inference of the recommendation value, a specific value is inferred as the recommendation value. In this case, the processing unit 440 executes inference by using a regression model as the inference model. A specific inference method of using the regression model may be any method of using the related art, and is not particularly limited herein.

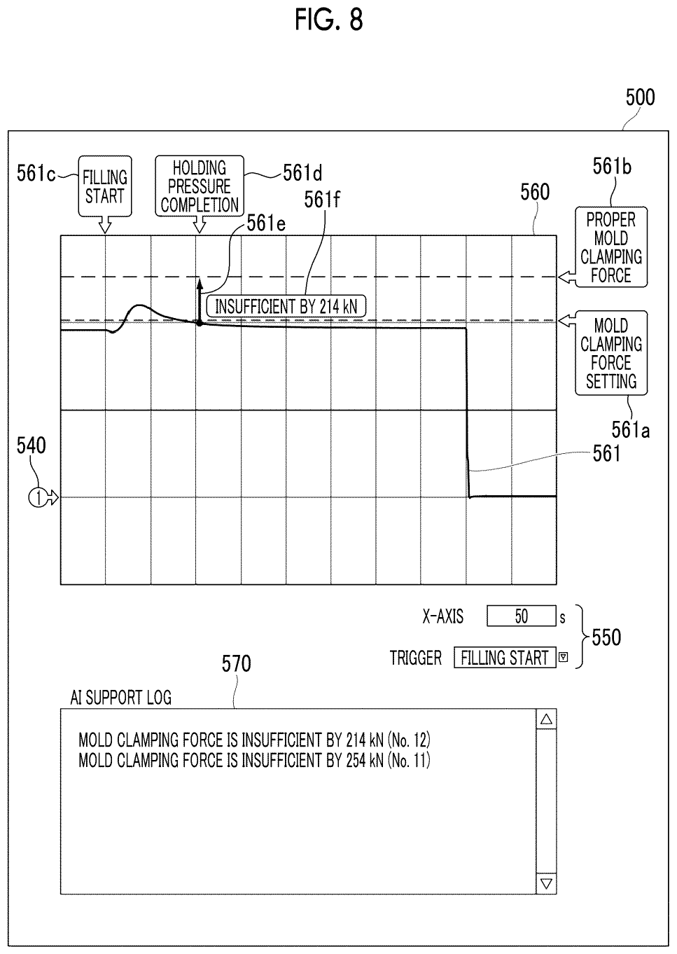

FIG. 8 is a view illustrating another example of the display screen 500 to which the reference information is added. Although a basic configuration of the display screen 500 is the same as that of the display screen 500 in FIGS. 6 and 7, in the display screen 500 illustrated in FIG. 8, the X-Y-axis unit display section 510, the command operation section 520, and the item display sections 531 to 534 are omitted in the description. In addition, in the waveform display section 560 illustrated in FIG. 8, only the waveform diagram 561 of the measurement value of the mold clamping force assigned to the first channel is displayed. As in the display screen 500 in FIG. 7, the waveform display section 560 illustrated in FIG. 8 displays the label 561a indicating the setting value of the mold clamping force, the label 561b indicating the recommendation value of the mold clamping force, the label 561c indicating the trigger position (filling start time), the label 561d indicating the holding pressure completion time, and the arrow 561e indicating the difference between the actual value (waveform diagram 561) and the recommendation value at the holding pressure completion time.

The display screen 500 illustrated in FIG. 8 displays a text as the additional display. In FIG. 8, as display means of the text, the display on the waveform display section 560 and a text display section 570 are illustrated. Specifically, as the display on the waveform display section 560, a text box 561f is displayed in the vicinity of the arrow 561e of the waveform display section 560. The text display section 570 is provided below the waveform display section 560 and the setting information display section 550.

The text box 561f sets a display position in accordance with a type of the target item or a type of the reference information assigned to the channel of the waveform diagram, and displays the message using the text. The target item of the waveform diagram 561 displayed on the waveform display section 560 in FIG. 8 is the mold clamping force, and the recommendation value of the mold clamping force is displayed as the reference information. In addition, a difference between the actual value and the recommendation value at the holding pressure completion time is illustrated by the additional display of the arrow 561e. Therefore, as a display example in this case, the text box 561f is displayed in the vicinity of the arrow 561e, and a message indicating “insufficient by 214 kN” is displayed. This message indicates that the actual value of the mold clamping force at the holding pressure completion time is smaller than the recommendation value by 214 kN. For example, a message displayed in the text box 561f can be prepared by preparing a message pattern such as “insufficient by kN”, and by inserting the value of the difference between the actual value and the recommendation value at a target position.

The text display section 570 is displayed at a proper position on the display screen 500, and displays the message using the text. In the example illustrated in FIG. 8, the text display section 570 is displayed together with a title of “AI support log”, and a message indicating “the mold clamping force is insufficient by 214 kN (No. 12)” and a message indicating “the mold clamping force is insufficient by 254 kN (No. 11)” are displayed. The displays indicating “No. 12” and “No. 11” which are included in the message indicate shot numbers. Therefore, the text display section 570 displays information on a plurality of shots in the past. When two messages are referred to, in the shot number 11 (No. 11), the actual value of the mold clamping force is insufficient by 254 kN than the recommendation value, but in the shot number 12 (No. 12), the actual value of the mold clamping force is insufficient by 214 kN than the recommendation value. Therefore, the setting of the mold clamping force is changed from a log message of the text display section 570 after the shot of the shot number 11. As a result, a slight improvement is observed in the shot of the shot number 12, but it is understood that the value is still insufficient than the recommendation value. For example, a message displayed on the text display section 570 can be prepared by preparing a message pattern such as “the mold clamping force is insufficient by kN (No.)”, and by inserting the value of the difference between the actual value and the recommendation value at the target position, and the shot number.

Here, the text box 561f and the text display section 570 have been described as examples of text display means. The display via the text box 561f enables the user to visually recognize and identify which setting value in the setting values displayed on the waveform display section 560 is a target, and to what extent the setting value is different from the recommendation value at any position in the waveform. On the other hand, the display via the text display section 570 enables the user to collectively visually recognize the difference between the setting value and the recommendation value which is generated in the waveform diagram displayed on the waveform display section 560. The user can refer to the display of the text box 561f and the text display section 570 in accordance with the features. A display method of the text as the additional display is not limited to the above-described method. A display position or a display method of the text, a content of the text, and the like can be appropriately set.

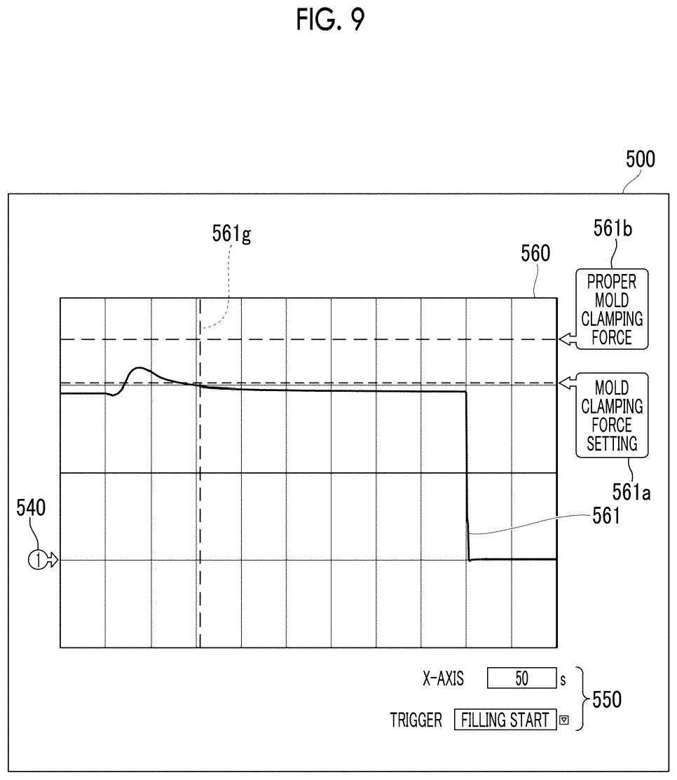

FIG. 9 is a view illustrating another example of the display screen 500 to which the reference information is added. Although a basic configuration of the display screen 500 is the same as that of the display screen 500 in FIGS. 6 and 7, in the display screen 500 illustrated in FIG. 9, the X-Y-axis unit display section 510, the command operation section 520, and the item display sections 531 to 534 are omitted in the description. In addition, in the waveform display section 560 illustrated in FIG. 9, only the waveform diagram 561 of the measurement value of the mold clamping force assigned to the first channel is displayed. As in the display screen 500 in FIG. 7, the waveform display section 560 illustrated in FIG. 9 displays the label 561a indicating the setting value of the mold clamping force and the label 561b indicating the recommendation value of the mold clamping force.

FIG. 9 illustrates an example of a display mode different from a display example in FIG. 7 with regard to the display of a specific time point (here, the holding pressure completion time) as the additional display. On the display screen 500 illustrated in FIG. 9, a broken line 561g parallel to the Y-axis (vertical direction) is displayed as the additional display at a position at the holding pressure completion time on the X-axis of the waveform display section 560 (position where the label 561d is disposed in FIG. 7). An intersection point between the broken line 561g and the waveform diagram 561 indicates an actual value of the mold clamping force at the holding pressure completion time. In addition, although not illustrated in FIG. 9, as in the display example in FIG. 7, the additional display indicating the trigger position (filling start time) may be performed. In addition, the label 561d similar to the display example in FIG. 7 may be displayed in association with the broken line 561g.

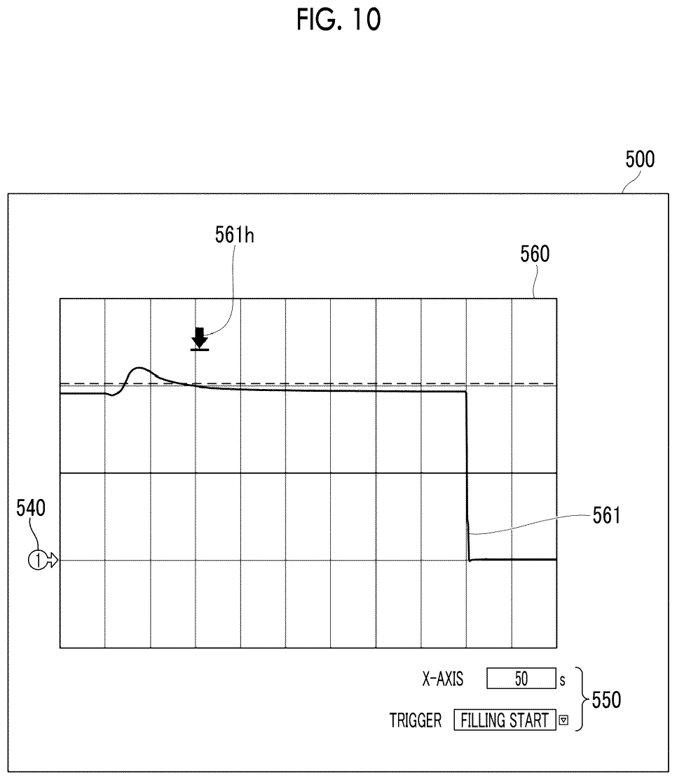

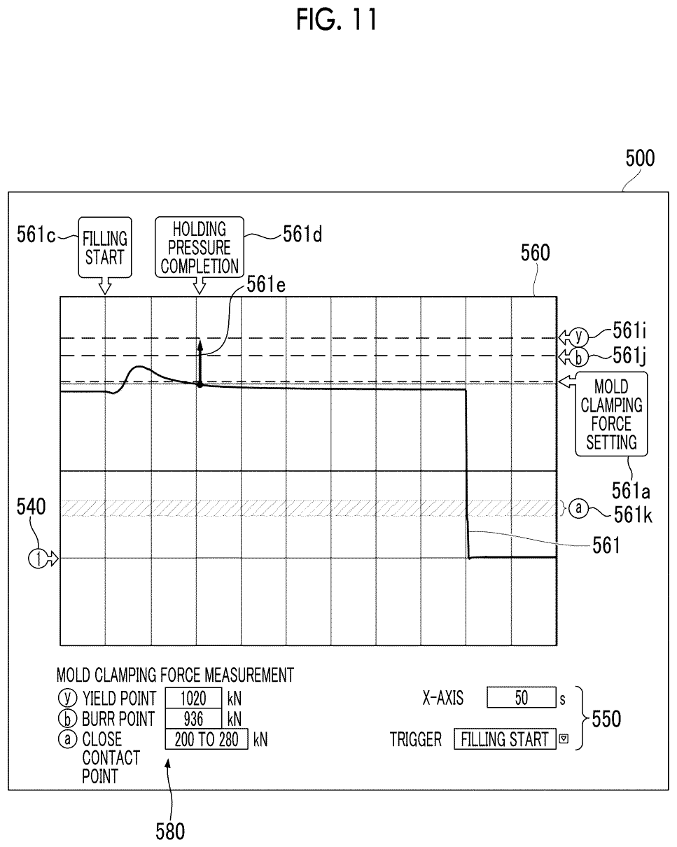

FIG. 10 is a view illustrating another example of the display screen 500 to which the reference information is added. Although the basic configuration of the display screen 500 is the same as that of the display screen 500 in FIGS. 6 and 7, in the display screen 500 illustrated in FIG. 10, the X-Y-axis unit display section 510, the command operation section 520, and the item display sections 531 to 534 are omitted in the description. In addition, in the waveform display section 560 illustrated in FIG. 10, only the waveform diagram 561 of the measurement value of the mold clamping force assigned to the first channel is displayed.

FIG. 10 illustrates an example of a display mode different from the display example in FIG. 7 with regard to the display of a specific time point (here, the holding pressure completion time) as the additional display. On the display screen 500 illustrated in FIG. 10, a broken line parallel to the X-axis (horizontal direction) is displayed as the additional display at a position of the setting value of the mold clamping force on the Y-axis of the waveform display section 560 (position where the label 561a is disposed in FIG. 7). The broken line is the same as the broken line displayed in association with the label 561a in FIG. 7.

In addition, the display screen 500 illustrated in FIG. 10 displays a marker 561h indicating the recommendation value of the mold clamping force at the holding pressure completion time. The marker 561h includes a short line segment parallel to the X-axis and a thick arrow directed toward the line segment. The line segment includes a position at the holding pressure completion time in the X-axis direction (horizontal direction), and is disposed at a position corresponding to the recommendation value of the mold clamping force at the holding pressure completion time in the Y-axis direction (vertical direction). The tip of the arrow is in contact with the line segment, and is a position at the holding pressure completion time in the X-axis direction (horizontal direction). Therefore, the illustrated marker 561h indicates the recommendation value of the mold clamping force at the holding pressure completion time at a position where the tip of the arrow is in contact with the line segment. In addition, although not illustrated in FIG. 10, as in the display example in FIG. 7, the additional display indicating the trigger position (filling start time) may be performed. In addition, the label 561a similar to the display example in FIG. 7 may be displayed in association with the broken line indicating the setting value of the mold clamping force.

In the example illustrated in FIG. 10, in the waveform display section 560, when a figure indicating the recommendation value which is the inferred value is displayed together with the waveform diagram (in the illustrated example, the waveform diagram 561), a marker (in the illustrated example, the marker 561h) including the line segment and the arrow is added. Here, this configuration is an example of the figure indicating an inferred value of the marker. As in the line and the label which are described with reference to FIG. 8, it is preferable that the marker is also displayed to overlap the display of the actual value or the setting value on the waveform display section 560. In the example illustrated in FIG. 10, the label is not added, but the label indicating the inferred value indicated by the marker may be added. In addition, instead of the label, the text box described with reference to FIG. 9 may be displayed in the vicinity of the marker, and the inferred value may be added.

FIG. 11 is a view illustrating another example of the display screen 500 to which the reference information is added. Although the basic configuration of the display screen 500 is the same as that of the display screen 500 in FIGS. 6 and 7, in the display screen 500 illustrated in FIG. 11, the X-Y-axis unit display section 510, the command operation section 520, and the item display sections 531 to 534 are omitted in the description. In addition, in the waveform display section 560 illustrated in FIG. 11, only the waveform diagram 561 of the measurement value of the mold clamping force assigned to the first channel is displayed. As in the display screen 500 in FIG. 7, the waveform display section 560 illustrated in FIG. 11 displays the label 561a indicating the setting value of the mold clamping force, the label 561c indicating the trigger position (filling start time), and the label 561d indicating the holding pressure completion time.

As the reference information, the display screen 500 illustrated in FIG. 11 presents a plurality of inference values, instead of the recommendation value (single value) of the mold clamping force. In the illustrated example, three types of recommendation values are illustrated by three of a label 561i (label on which “y” is written), a label 561j (label on which “b” is written), and a label 561k (label on which “a” is written) which are disposed on the Y-axis (right side) of the waveform display section 560. In the waveform display section 560, a broken line parallel to the X-axis (horizontal direction) is displayed at positions corresponding to the label 561i and the label 561j. In addition, the label 561k includes a constant range in the Y-axis direction, and a band parallel to the X-axis (horizontal direction) having a width corresponding to the range is displayed on the waveform display section 560. The labels 561i, 561j, and 561k, the broken line, and the band are examples of the additional display.

In addition, the display screen 500 is provided with an inference value item display section 580. The inference value item display section 580 is a display section that displays information on a plurality of inference values. A title of “mold clamping force measurement” indicating the information corresponding to the first channel is displayed on the inference value item display section 580, and contents and values of the inference values illustrated in the labels 561i, 561j, and 561k displayed on the waveform display section 560 are displayed on the inference value item display section 580.

In the inference value item display section 580 illustrated in FIG. 11, the inference value of the label 561i is the mold clamping force at a yield point in a mold clamping process, and indicates that the value of the mold clamping force at the yield point is 1,020 kN. The yield point is a point at which the mold clamping force falls below a filling pressure of a molding material. In addition, the inference value of the label 561j is the mold clamping force at a burr point in the mold clamping process, and indicates that the value of the mold clamping force at the burr point is 936 kN. The burr point is a point at which the molding material is solidified without the mold being completely closed and a burr is generated in the molding product. In addition, the inference value of the label 561k is the mold clamping force at a close contact point in the mold clamping process, and indicates that the value of the mold clamping force at the close contact point is 200 to 280 kN. The close contact point is a point at which a stationary mold and a movable mold are in close contact with each other. The user can refer to the inference values, and can select and set a desired mold clamping force. When the yield point is used as the recommendation value, as illustrated in FIG. 11, the arrow 561e directed toward the yield point from a position at the holding pressure completion time of the waveform diagram 561 may be displayed, and a difference between the actual value and the yield point may be displayed.

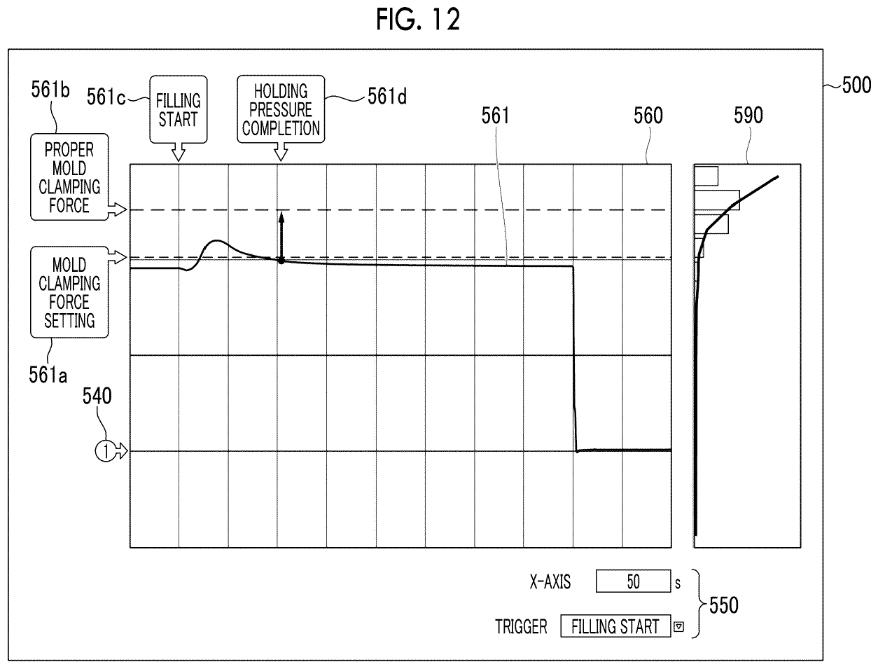

FIG. 12 is a view illustrating another example of the display screen 500 to which the reference information is added. Although the basic configuration of the display screen 500 is the same as that of the display screen 500 in FIGS. 6 and 7, in the display screen 500 illustrated in FIG. 12, the X-Y-axis unit display section 510, the command operation section 520, and the item display sections 531 to 534 are omitted in the description. In addition, in the waveform display section 560 illustrated in FIG. 12, only the waveform diagram 561 of the measurement value of the mold clamping force assigned to the first channel is displayed. As in the display screen 500 illustrated in FIG. 7, the waveform display section 560 illustrated in FIG. 12 displays the label 561a indicating the setting value of the mold clamping force, the label 561b indicating the recommendation value of the mold clamping force, the label 561c indicating the trigger position (filling start time), and the label 561d indicating the holding pressure completion time.

The display screen 500 illustrated in FIG. 12 presents certainty (confidence level) of the recommendation value of the mold clamping force as the reference information. In the display examples illustrated in FIGS. 7 to 11, a specific value such as the recommendation value and the inference value is inferred as the reference information, and is presented on the display screen 500. In this case, the processing unit 440 executes inference by using a regression model as the inference model. In contrast, in the display example illustrated in FIG. 12, in addition to the presentation of the recommendation value, an inference result is inferred as a distribution of the certainty of a plurality of values as reference information, and is presented on the display screen 500. In this case, the processing unit 440 executes inference by using a classification model as the inference model. In the inference using the classification model, first, the setting value (settable value instead of a currently set value) in the target item or an adjustment amount thereof is classified into a plurality of sections. A probability that the value of the inference result corresponds to each section is obtained. This probability indicates the certainty of the section as the recommendation value. In addition, a specific inference method using the classification model may be any method in the related art, and the present invention is not particularly limited thereto.

The display screen 500 illustrated in FIG. 12 is provided with certainty display section 590 on the right side of the waveform display section 560 of the display screen 500. The certainty display section 590 classifies the settable mold clamping forces into a plurality of sections, and the certainty of each section is displayed by using a bar graph. The length of the bar graph in each section indicates a high probability that the value of the inference result corresponds to the section. In addition, the certainty display section 590 displays a cumulative value of the probability for each section by using a line graph.

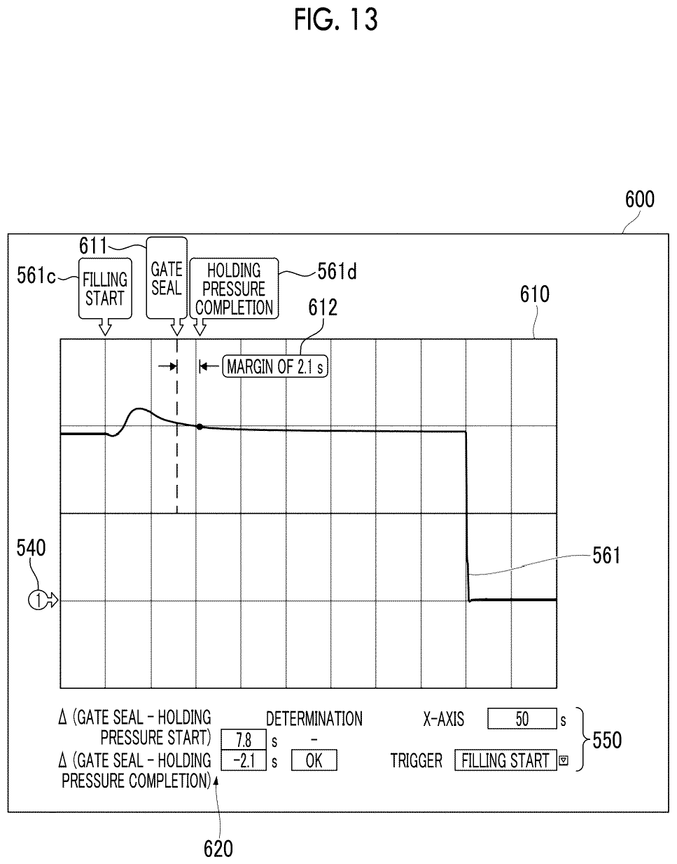

FIG. 13 is a view illustrating an example of a display screen 600 to which the reference information is added. Although the basic configuration of the display screen 600 is the same as that of the display screen 500 in FIGS. 6 and 7, in the display screen 600 illustrated in FIG. 13, the X-Y-axis unit display section 510, the command operation section 520, and the item display sections 531 to 534 are omitted in the description. In addition, the waveform display section 610 illustrated in FIG. 13 is configured in the same manner as the waveform display section 560 illustrated in FIGS. 6 and 7. However, in the illustrated example, only the waveform diagram 561 of the measurement value of the mold clamping force assigned to the first channel is displayed. In addition, as in the display screen 500 in FIG. 7, the waveform display section 610 illustrated in FIG. 13 displays the label 561c indicating the trigger position (filling start time) and the label 561d indicating the holding pressure completion time.

The display screen 600 illustrated in FIG. 13 presents a time (gate seal time) at which gate seal occurs as the reference information. In the display examples illustrated in FIGS. 7 to 12, the inference is executed on the mold clamping force, and is presented on the display screen 500. In contrast, in the display example illustrated in FIG. 13, the gate seal time is inferred and presented on the display screen 600. In the illustrated example, a label 611 indicating the gate seal time and a text box 612 are displayed as the additional display of the waveform display section 610.

The label 611 is disposed at a specific position (between the label 561c and the label 561d) on the X-axis of the waveform display section 610 indicating the inferred gate seal time. In addition, in the waveform display section 610, a broken line parallel to the Y-axis (vertical direction) is displayed at a position corresponding to the label 611. The gate seal time indicated by the label 611 and the holding pressure completion time indicated by the label 561d are displayed by two arrows facing each other. The text box 612 is displayed in the vicinity of the arrows, and a message indicating “a margin of 2.1 s” is displayed. This message indicates that there is 2.1 s (seconds) from the gate seal time to the holding pressure completion time. The holding pressure at the molding time needs to be completed when the gate seal occurs inside the mold and there is no backflow of the molding material. Therefore, it can be understood that the setting at the holding pressure completion time is proper in the illustrated example.

In addition, a gate seal information display section 620 is displayed on the display screen 600 as the additional display. In the example illustrated in FIG. 13, a text box displaying an item and the number of seconds of “gate seal-holding pressure start” indicating a time from the holding pressure start time to a gate seal time, a text box displaying an item and the number of seconds of “gate seal-holding pressure completion” indicating a time from the holding pressure completion time to the gate seal time, and a text box displaying a determination result are displayed. In the illustrated example, “7.8” is displayed as the number of seconds of “gate seal-holding pressure start”. Therefore, the time from the holding pressure start time to the gate seal time is 7.8 seconds. In addition, “−2.1” is displayed as the number of seconds for “gate seal-holding pressure completion”. Therefore, the time from the holding pressure completion time to the gate seal time is −2.1 seconds. In other words, the time from the gate seal time to the holding pressure completion time is 2.1 seconds. In addition, the determination result is displayed as “OK”. That is, since there are 2.1 seconds from the gate seal time to the holding pressure completion, the result indicates that the setting of the holding pressure completion time as the molding condition is proper.

For example, the gate seal time can be inferred by using an inference model such as machine learning to which the screw position, the measurement value of the holding pressure, and the measurement value of the mold clamping force are input. The gate seal time is not a target that is inferred as the recommendation value of the setting values of the molding conditions or the like. However, the operation during the shot is a point at which an event is changed. As described above, the holding pressure needs to be completed at a time later than the gate seal time. Therefore, the point can be used as a guide for settings in the holding pressure operation.

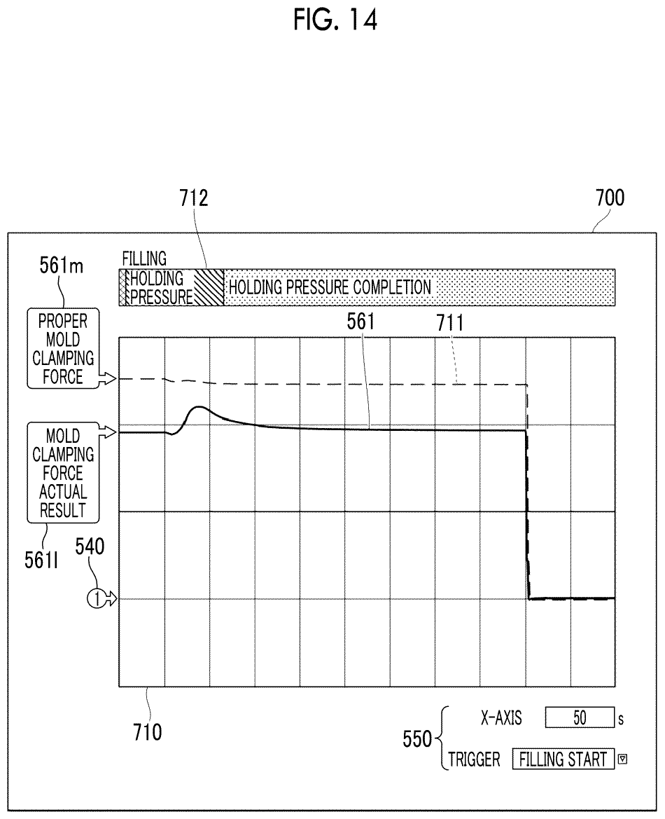

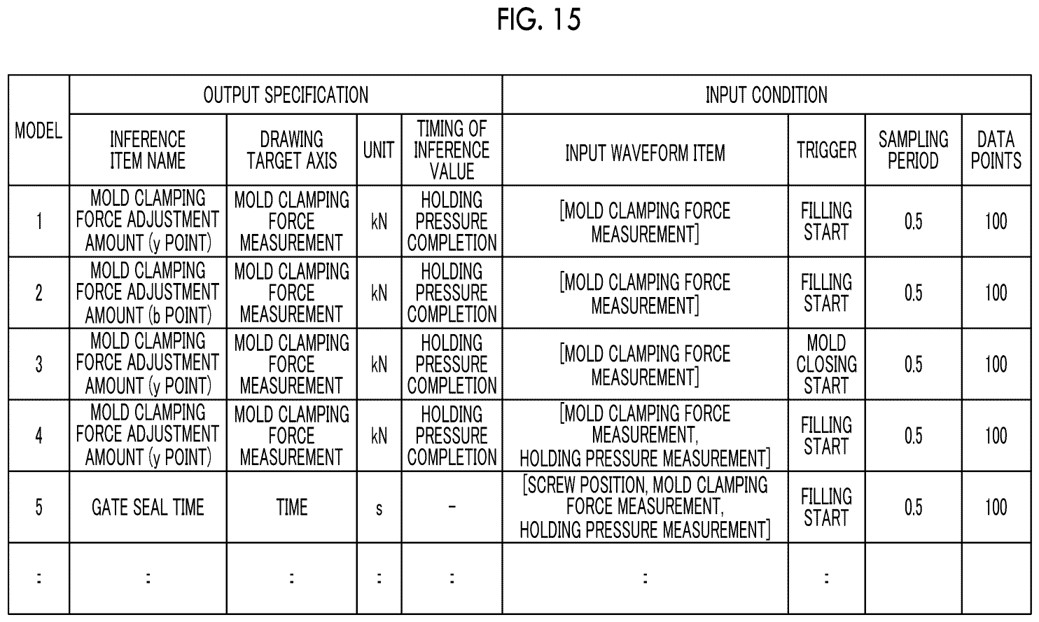

FIG. 14 is a view illustrating an example of a display screen 700 to which the reference information is added. Although the basic configuration of the display screen 700 is the same as that of the display screen 500 in FIGS. 6 and 7, in the display screen 700 illustrated in FIG. 14, the X-Y-axis unit display section 510, the command operation section 520, and the item display sections 531 to 534 are omitted in the description. In addition, in the waveform display section 710 illustrated in FIG. 14, only the waveform diagram 561 of the measurement value of the mold clamping force assigned to the first channel is displayed. In the waveform display section 710 illustrated in FIG. 14, a label 561l (label on which the “mold clamping force actual result” is written) is disposed at a position on the Y-axis (left side) corresponding to the waveform diagram 561 based on the actual value.

The display screen 700 illustrated in FIG. 14 presents the waveform diagram of the proper mold clamping force obtained by inference and information indicating a phase transition, as the reference information. In any of the display examples illustrated in FIGS. 7 to 12, the recommendation value (inference value) of the mold clamping force at the holding pressure completion time is displayed as the reference information. In contrast, in the display example illustrated in FIG. 14, the waveform display section 710 displays an inferred waveform diagram 711 of the mold clamping force in the shot. A label 561m (label on which the “proper mold clamping force” is written) is disposed at a position on the Y-axis (left side) corresponding to the waveform diagram 711 of the waveform display section 710. In the display examples illustrated in FIGS. 7 to 13, a time (filling start time, holding pressure completion time, or the like) at which a specific event occurs in the shot is specified and displayed by the label or the like. In contrast, in the display example illustrated in FIG. 14, a band graph 712 corresponding to a section displayed on the waveform display section 710 in the shot indicates a state transition relating to the specific event.

The waveform diagram 711 illustrated in FIG. 14 is obtained by calculating the recommendation value (inference value) of the mold clamping force in the shot as time-series data. In this inference, a so-called encoder-decoder model is used to obtain a low-dimensional latent space. For example, the inference model for inferring a waveform from a waveform (time-series data from time-series data) can be acquired by learning a pair of a waveform of the actual value under various conditions or situations and a desirable waveform as an inference result. The inferred waveform is obtained as the same array (vector) data as that of the waveform of the actual value. Therefore, the inferred waveform can be displayed on the waveform display section 710 by performing the same drawing processing as that for drawing the waveform diagram 561 on the waveform display section 710.

The band graph 712 illustrated in FIG. 14 illustrates a state transition after filling the mold with the molding material, the holding pressure, and the holding pressure completion. In this manner, the user can easily visually recognize a relationship between a state transition in the operation of the section of the shot displayed on the waveform display section 710 and the waveform diagrams 561 and 711. In the illustrated example, the state transition relating to the holding pressure is illustrated. However, without being limited thereto, various state transitions that can be compared with the waveform diagrams may be displayed depending on a type of the target item. For example, a state transition (mold complete closing, mold opening completion, or the like) in the mold clamping process may be displayed. Furthermore, description in the band graph 712 may be description indicating a process known to a user, such as a filling process, a holding pressure process, and the like, instead of description indicating a state such as “filling” and “holding pressure”.

### Inference Execution Condition

Next, an inference execution condition of the processing unit 440 will be described. The processing unit 440 executes the inference relating to the target item by using the inference model such as machine learning. Here, the condition under which the inference is possible varies depending on the inference model. More specifically, the condition under which the inference is possible is determined depending on what type of data is used during the design and the training of the inference model. Therefore, the inference via the processing unit 440 is executed in the shot after the data of the actual values corresponding to data points that can be inferred is acquired.

FIG. 15 is a view illustrating an example of the inference execution condition for each model. In the example illustrated in FIG. 15, an output specification of the inference result and an input condition for executing the inference are associated with each other for each model. The output specification includes an “inference item name”, a “drawing target axis”, a “unit”, and a “timing for the inference value”. The “inference item name” is an item name of the value to be inferred. In the example illustrated in FIG. 15, a “mold clamping force adjustment amount (y point)”, a “mold clamping force adjustment amount (b point)”, a “gate seal time”, and the like are registered. The “y point” and the “b point” of the mold clamping force adjustment amount indicate “y” of the yield point and “b” of the burr point in the inference value described with reference to FIG. 11. The “drawing target axis” indicates a target axis displaying the inference result. In the example illustrated in FIG. 15, “mold clamping force measurement” and a “time” are registered. The “unit” is a unit of a value displayed by using the drawing target axis as a target. In the example illustrated in FIG. 15, the unit for the “mold clamping force measurement” is “kN”, and the unit for the “time” is “s” (seconds). The “timing for the inference value” indicates a time point at which the inference is executed during the operation of the shot. In the example illustrated in FIG. 15, as the timing for the inference value of the “mold clamping force adjustment amount”, the holding pressure completion time (in the drawing, the “holding pressure completion” is written) is registered.

In addition, the input condition includes an “input waveform item”, a “trigger”, a “sampling period”, and “data points”. The “input waveform item” is a type of time-series data that is input for the inference. The “trigger” is a reference time point for specifying a time point serving as an inference target during the operation of the shot, and indicates a trigger position. The “sampling period” is a sampling period of the time-series data of the input waveform item. The “data points” are the data points of the time-series data of the input waveform item required for the inference.

Therefore, in the example illustrated in FIG. 15, for example, a model 1 is a model in which the inference item name is a “mold clamping force adjustment amount (y point)” and y: yield point described with reference to FIG. 11 is inferred as the inference value at the holding pressure completion time. The inference result is displayed in units of kN in association with the target axis (Y-axis) on which the waveform diagram 561 of the measurement value (actual value) of the mold clamping force is drawn on the waveform display section 560. In addition, the inference is executed under a condition that 100 measurement values of the mold clamping force after the filling start time are acquired at a sampling period of 0.5 seconds.

In addition, as in the model 1, a model 4 is used for inferring the “mold clamping force adjustment amount (y point)”. However, unlike the model 1, the model 4 executes the inference by sampling the measurement value of the holding pressure as the input waveform in addition to the measurement value of the mold clamping force.

A model 5 is a model in which the inference item name is a “gate seal time” and the gate seal time is inferred. The inference result is displayed in units of s (seconds) on the waveform display section 560 in association with the time axis (X-axis). In addition, the inference is executed under a condition that 100 measurement values of the mold clamping force after the filling start time are acquired at a sampling period of 0.5 seconds.

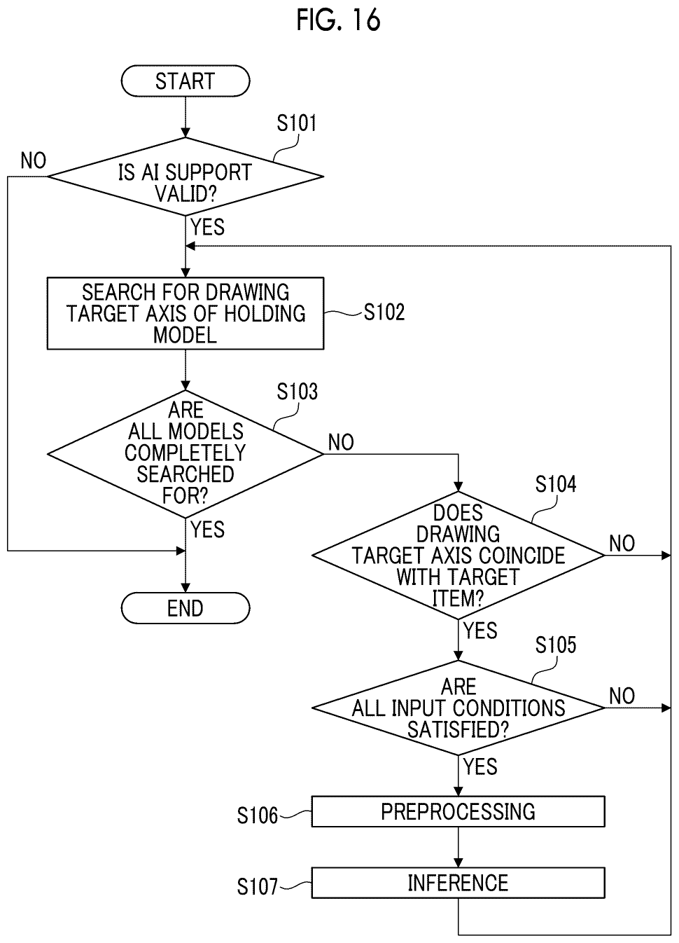

FIG. 16 is a flowchart illustrating an operation of the processing unit 440 when the inference is executed based on conditions illustrated in FIG. 15. A condition table and an inference model used for inference as illustrated in FIG. 15 are held in the storage unit 450 of the information processing device 400. The processing unit 440 refers to the condition table, and determines whether or not information on the target item acquired by the communication unit 410 satisfies the input condition in the condition table. In this case, the processing unit 440 functions as a determination unit.

The processing unit 440 first determines whether or not the AI support is valid for each channel to which the target item is assigned. The AI support is valid when the check boxes of the “AI support” of the display setting fields 531f to 534f described with reference to FIG. 7 are checked. When the AI support is invalid (not checked) (NO in S101), the processing unit 440 completes the processing without executing the inference.

When the AI support is valid (checked) (YES in S101), the processing unit 440 refers to the condition table held in the storage unit 450, and sequentially searches for the drawing target axis of the inference model (in the drawing, a “holding model” is written) (S102). When the drawing target axis of the searched model does not coincide with the drawing target axis of the inference target item (NO in S103 and NO in S104), the processing returns to S102, and the processing unit 440 searches for one of the drawing target axes of the inference models which are not searched for.

When the drawing target axis of the searched model coincides with the drawing target axis of the inference target item (NO in S103 and YES in S104), the processing unit 440 subsequently determines whether or not all of the input conditions of the searched model are satisfied. When the input condition is not satisfied (NO in S105), the processing returns to S102, and the processing unit 440 searches for one of the drawing target axes of the inference models which are not searched for.

When the input condition of the model searched in S102 is satisfied (YES in S105), the processing unit 440 performs preprocessing for executing the inference on the time-series data or the like of the acquired target item (S106), and executes the inference by inputting preprocessed data to the inference model (S107). Thereafter, the processing unit 440 returns to S102, and searches for one of the drawing target axes of the inference models which are not searched for. When the drawing target axes for all of the inference models are completely searched for (YES in S103), the processing unit 440 displays the inference result on the display screen 500, and completes the processing.

Hitherto, the embodiments of the present invention have been described. Meanwhile, the technical scope of the present invention is not limited to the above-described embodiments. For example, in the above-described embodiment, in the examples illustrated in FIGS. 7 and 8, the difference between the recommendation value serving as the inference result and the actual value illustrated in the waveform diagram 561 is displayed by using the arrow 561e. In contrast, a configuration may be adopted in which a difference between the setting value and the recommendation value in the shot in which the waveform diagram 561 is obtained is displayed.

In addition, in the above-described embodiment, the information processing device 400 has the inference model, and is configured to execute the inference based on the actual value. In contrast, a configuration may be adopted as follows. An inference engine is provided in a server (cloud server or the like) on the network, and the inference is executed as a Web service or the like. In this case, the information processing device 400 acquires the inference result from the server, and as described with reference to FIGS. 7 to 14, the inference result is displayed together with the waveform diagram of the corresponding item on the waveform display sections 560, 610, and 710, as the additional display indicating the reference information based on the inference result. In this configuration, the processing unit 440 of the information processing device 400 functions as an acquisition unit that acquires the inference data of the information relating to the injection molding through communication. In addition, the data processing device 200 of the injection molding machine 10 may have the inference engine, and may be configured to execute the inference. In this case, the display unit 300 may be used to display the inference result. In addition, various modifications and configuration alternatives which do not depart from the scope of the technical idea of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing system comprising:
an acquisition unit that acquires an inference result of information relating to injection molding inferred based on information relating to a shot in the injection molding and information obtained in the shot; and
a display control unit that causes a display unit to display a display screen which includes a waveform diagram indicating a temporal change in an actual value obtained in the shot, by using a waveform, and on which reference information based on the inference result is added to the waveform diagram.

2. The information processing system according to claim 1,
wherein the reference information is a value inferred with regard to a target item which is a target of the waveform diagram, and a figure indicating the reference information is displayed on the display screen together with the waveform diagram.

3. The information processing system according to claim 2,
wherein the display control unit performs a display indicating a difference between an actual value of the target item at a specific time point in the shot and the inferred value of the target item at the specific time point.

4. The information processing system according to claim 2,
wherein the display control unit displays a setting value of the target item in the shot.

5. The information processing system according to claim 2,
wherein the display control unit performs a display indicating a difference between a setting value of the target item in the shot and the inferred value of the target item at a specific time point.

6. The information processing system according to claim 1,
wherein the reference information is a display indicating a time point at which a specific event occurs during an operation of the shot.

7. The information processing system according to claim 6,
wherein the display control unit displays a relationship between the time point at which the specific event occurs and a specific time point different from the time point at which the specific event occurs in the shot.

8. The information processing system according to claim 1,
wherein the reference information is time-series data, and is displayed as a waveform diagram together with the waveform diagram of the actual value.

9. The information processing system according to claim 1, further comprising:
a reception unit that receives a user's operation of an input unit,
wherein the reception unit transmits an instruction corresponding to the received operation to the display control unit or the acquisition unit.

10. The information processing system according to claim 1, further comprising:
a storage unit,
wherein the storage unit holds a data file of the information relating to the shot in the injection molding and the information relating to the injection molding obtained by inference.

11. The information processing system according to claim 10,
wherein the data file is held in association with a manufacturing target molding product or a mold in the shot.

12. The information processing system according to claim 11,
wherein the storage unit further holds an inference model used for inference of the acquisition unit.

13. An information processing system comprising:
an acquisition unit that acquires information relating to a shot in injection molding;
an inference execution unit that executes inference of information relating to the injection molding inferred based on information obtained in the shot; and
a display control unit that causes a display unit to display a display screen which includes a waveform diagram indicating a temporal change in an actual value obtained in the shot, by using a waveform, and on which reference information based on a result of the inference executed by the inference execution unit is added to the waveform diagram.

14. The information processing system according to claim 13, further comprising:
a determination unit that determines whether or not a condition for executing inference set for each inference model used for the inference is satisfied, based on the acquired information relating to the shot,
wherein the inference execution unit executes the inference when the determination unit determines that the condition is satisfied.

15. A non-transitory computer readable medium storing a program, the program when executed by a computer, causing the computer to:
function as an acquisition unit that acquires an inference result of information relating to injection molding inferred based on information relating to a shot in the injection molding and information obtained in the shot; and
function as a display control unit that causes a display unit to display a display screen which includes a waveform diagram indicating a temporal change in an actual value obtained in the shot, by using a waveform, and on which reference information based on the inference result is added to the waveform diagram.

16. A non-transitory computer readable medium storing a program, the program when executed by a computer, causing the computer to:
function as an acquisition unit that acquires information relating to a shot in injection molding;
function as an inference execution unit that executes inference of information relating to the injection molding inferred based on information obtained in the shot; and
function as a display control unit that causes a display unit to display a display screen which includes a waveform diagram indicating a temporal change in an actual value obtained in the shot, by using a waveform, and on which reference information based on a result of the inference is added to the waveform diagram.
